(19) United States
(12) Patent Application Publication
(10) Pub. No.: US 2005/0254100 A1
(43) Pub. Date: Nov. 17, 2005

(54) Ticket exchange for combating fax spam

(75) Inventors: Amin El-Gazzar, Key Biscayne, FL (US); Ralph Musgrove, Toronto (CA)

Correspondence Address: CHRISTOPHER & WEISBERG, P.A., 200 EAST LAS OLAS BOULEVARD, SUITE 2040, FORT LAUDERDALE, FL, 33301, US

(73) Assignee: Venali, Inc.

(21) Appl. No.: 10/847,117

(22) Filed: May 17, 2004

(51) Int. Cl. H04N 1/00

(52) U.S. Cl. 358/404; 358/400

(57) ABSTRACT

A fax transmission system configured to combat spam in a fax network. The system can include a fax transmission processsor coupled to a ticket service and configured to transmit selected facsimile images only when the ticket service validates corresponding ones of tickets issued by the ticket service. Notably, both the fax transmission processor and the ticket service can be disposed in a broadcast fax network.

### BACKGROUND OF THE INVENTION

1. Statement of the Technical Field

The present invention relates to the field of unsolicited electronic communications (hereinafter “spam”), and more particularly to a ticket service for reducing the transmission of spam.

2. Description of the Related Art

Second only to the telephone, the facsimile device remains a principal mode of commercial communications. At present, more than eighty-five million facsimile devices have been deployed worldwide and more than one and one-half billion facsimile telephone numbers have been publicly disseminated. Consequently, it should be no surprise that the direct marketing industry has incorporated the facsimile image as a means for mass broadcasting marketing messages in the same way the direct marketing industry has embraced the telephone and electronic mail as a mode of direct advertising.

Historically, the print medium served as the principal mode of unsolicited mass advertising on the part of the direct marketing industry. Typically referred to as “junk mail”, unsolicited print marketing materials could be delivered in bulk to a vast selection of recipients, regardless of whether the recipients requested the marketing materials. With an average response rate of one to two percent, junk mail has been an effective tool in the generation of new sales leads. Nevertheless, recipients of junk mail generally find the practice to be annoying. Additionally, postage for sending junk mail can be expensive for significant “mail drops”. Consequently, the direct marketing industry constantly seeks equally effective, but less expensive modalities for delivering unsolicited marketing materials.

The advent of electronic mail has provided much needed relief for direct marketers as the delivery of electronic mail to a vast number of targeted recipients requires no postage. Moreover, the delivery of unsolicited electronic mail can be an instantaneous exercise and the unsolicited electronic mail can include embedded hyperlinks to product or service information thus facilitating an enhanced response rate for the “mail drop”. Still, as is the case in the realm of print media, unsolicited electronic mail, referred to commonly as “spam”, remains an annoyance to consumers worldwide. As a result, an entire cottage industry of “spam filters” has arisen whose task solely is the eradication of spam.

Like electronic mail, the facsimile medium remains a popular medium for broadcast marketing. Unlike electronic mail, however, there is a real cost to the consumer for receiving spam in the facsimile medium. In particular, a single spam facsimile image can consume paper and toner resource and can consume telecommunications bandwidth which otherwise can be used for sending outgoing facsimiles, or to received legitimate incoming facsimiles. In the United Kingdom, it is estimated that spam in the facsimile domain costs each British company in excess of three-hundred and seventy six pounds annually. In the United States, some estimates place the cost of spam in the facsimile domain at as high as nine-billion dollars per year!

In the electronic mail domain, The Weizmann Institute of Science of Rehovot, Israel, and Microsoft Research SVC of Mountain View, Calif. jointly have studied the problem of spam which has resulted in the creation of the “Penny Black” project. The Penny Black project draws its inspiration from the Penny Black stamp of days gone past. Prior to 1830, postage fees in Great Britain were based on weight and the distance between sender and recipient. The British Postal System, recognizing the unfairness of charging a recipient for unsolicited mail, developed the Penny Black system of charging the sender a single rate for system-wide mail in the form of a postage stamp. Hence, the Penny Black stamp shifted the cost of postage from the recipient to the sender and eliminated the complexity of postage computation by requiring a uniform, low rate.

Considering the Penny Black system of two centuries past, today's Penny Black project proposes the shifting of the cost of unsolicited electronic mail from the recipient to the sender. To that end, several techniques have been investigated, including charging the sender according to the number of CPU or memory cycles consumed to process spam. Additionally, the wide-scale deployment of Turing tests has been contemplated for detecting automated efforts to transmit spam and to ensure the involvement of a human in the process. Nevertheless, the most promising of all proposals arising out of the Penny Black project is the “ticket service”.

In the ticket service methodology, a sender of an electronic mail message first must prove to the recipient that a cost had been expended in transmitting the message. The cost can be expressed, for instance in terms of a minimal consumption of CPU cycles, or other such CPU-bound pricing. In the seminal paper, Cynthia Dwork, Andrew Goldberg and Moni Naor, On Memory-Bound Functions for Fighting Spam (Israel Science Foundation 2002), it had been further suggested that a pricing function be based not on the consumption of CPU cycles, but upon the computation of memory latencies as memory-bound functions are more equitable in nature than CPU-bound functions.

In any case, by requiring the consumption of computing resources to transmit a message, each transmitting computer can be bound by an upper-limit on the amount of messages which can be transmitted over a fixed period of time. Moreover, the increased cost to send a number of electronic mail messages can vary in a proportional manner to the amount of computing resources required by the pricing function. Hence, in the ticket service paradigm, a ticket service can ensure that only those senders who have undertaken some expense confirmed through the issuance of a ticket can transmit an electronic mail message to a recipient.

Though the ticket service methodology seems promising in the electronic mail domain, there exists no functional equivalent in the facsimile domain. Yet, the problem of spam in the electronic mail domain pales in comparison to that of the facsimile domain. In that regard, substantial resources are required to produce a “hard copy” fax image, while the receipt of an electronic mail message involves orders of magnitude less cost. Nevertheless, from an infrastructure perspective, the transmission of a facsimile differs substantially from the transmission of electronic mail. Accordingly, a Penny Black type project has not been implemented in the context of fax transmissions.

Notably, though a ticket service methodology does not exist in the fax domain, rudimentary data exchange algorithms have been applied to the transmission of fax images for purposes of security. For instance, in U.S. Pat. No. 5,671,285 to Newman and in U.S. Pat. Nos. 5,587,809 and 5,555,307 to Le Corre et al., public key exchanges are utilized within fax units to ensure the encrypted exchange of fax images. Similarly, in U.S. Pat. No. 5,452,099 to Von Meister, security codes can be exchanged between fax units to ensure that confidential documents are received only by the intended recipient. Each of the foregoing methodologies, however, does not act to shift the cost of transmitting spam imagery to the sender as is the case in a ticket exchange system.

### SUMMARY OF THE INVENTION

The present invention addresses the deficiencies of the art in respect to spam in the facsimile domain and provides a novel and non-obvious method, system and apparatus for implementing a ticket exchange within a fax network. In accordance with a preferred aspect of the invention, a fax transmission system can include a fax transmission processor coupled to a ticket service and configured to transmit selected facsimile images only when the ticket service validates corresponding ones of tickets issued by the ticket service. Notably, both the fax transmission processor and the ticket service can be disposed in a broadcast fax network.

One or more counters can be associated with corresponding ones of identifiable fax senders. Each counter can have a configuration for incrementing responsive to an invalid attempt to transmit a facsimile image on behalf of a corresponding one of the identifiable fax senders. Importantly, the fax transmission system can be further configured to block processing of selected facsimile images for a specific one of the identifiable fax senders when a corresponding one of the counters exceeds a threshold value. Moreover, a pricing function can be coupled to the ticket service and configured to determine whether tickets should be issued to requestors based upon a computation of resources consumed by the requesters.

A method for combating fax spam can include receiving a request to transmit a facsimile image from an identifiable sender. A ticket received in association with the request can be validated and cancelled responsive to the receipt of the request. In this regard, the request can be blocked if the ticket does not validate. Notably, a quantity of resources consumed by the identifiable sender in transmitting the facsimile image can be computed the ticket can be issued only if the computed quantity exceeds a threshold value. In any case, the identifiable sender can be notified by electronic mail when the ticket does not validate.

In a specific aspect of the present invention, a counter can be reset for the identifiable sender and the counter can be incremented each time a ticket received in association with a request from the identifiable sender does not validate. Subsequent requests from the identifiable sender can be blocked once the counter exceeds a threshold value. Importantly, notification for subsequent requests from the identifiable sender can be withheld as well once the counter exceeds a threshold value.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is block diagram illustrating a ticket exchange system configured for use in a fax network; and,

FIG. 2 is a flow chart illustrating a process of managing a ticket exchange in the transmission of a fax image from sender to recipient in the fax network of FIG. 1.

### DETAILED DESCRIPTION OF THE PREFERRED EMBODIMENTS

The present invention is a ticket exchange for combating spam in a fax network. In accordance with the present invention, a fax sending process can route a fax to an intended recipient only where a ticket provided in association with the fax can be authenticated. More particularly, prior to requesting the transmission of a fax, a fax sender first can obtain a ticket from a ticket service. Subsequently, the fax sender can request the transmission of the fax and the fax sender can provide the ticket in association with that request. If the ticket can be authenticated by the ticket service, the fax can be transmitted. Otherwise, the request to transmit the fax can be denied and a suitable notification can be provided to the fax sender.

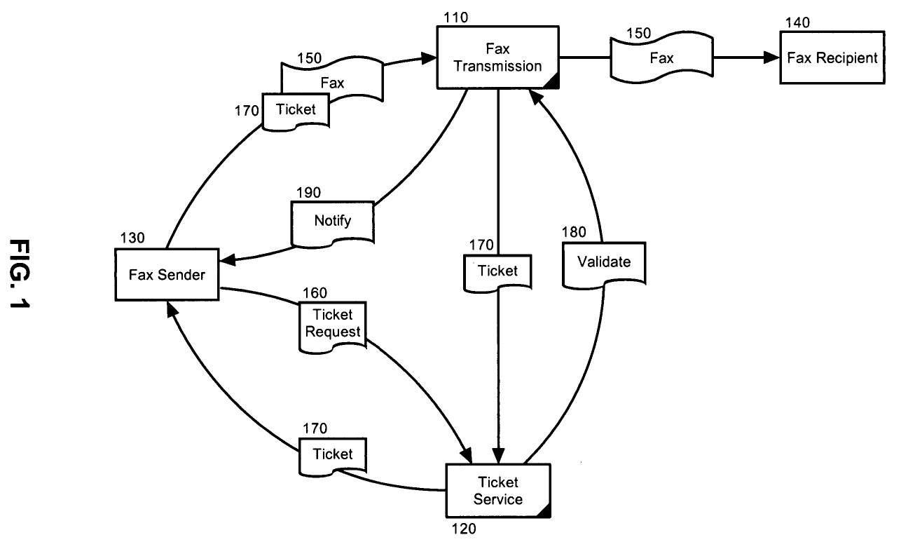

FIG. 1 is block diagram illustrating a ticket exchange system configured for use in a fax network. The ticket exchange system can include a fax transmission process 110 communicatively coupled to a ticket service 120. The fax transmission process 110 can include programming both for receiving from a fax sender 130 a fax 150 addressed to a fax recipient 140, and also for authenticating a ticket 170 through the ticket service 120 before transmitting the fax 150 to the intended fax recipient 140. The ticket service 120, in turn, can include programming both for issuing tickets 170 to fax senders 130, and for authenticating and canceling tickets 170 upon their use in transmitting a fax 150 to an intended recipient 140.

In operation, a fax sender 130 can forward a ticket request 160 to the ticket service 120 prior to requesting the transmission of a fax 150 to an intended fax recipient 140. Where the ticket service 120 concludes that the fax sender 130 is authorized to transmit a fax 150, the ticket service 120 can issue a ticket 170. Upon receipt of the ticket 170, the fax sender 130 can associate the ticket 170 with a fax 150 and can forward both to the fax transmission process 110.

For each ticket 170 received in an attempt to transmit a fax 150, the fax transmission process 110 can forward the ticket 170 to the ticket service 120 for validation. If the ticket service 120 determines that the ticket 170 is valid, the ticket service 120 can validate the ticket 170 by forwarding a validation message 180 to the fax transmission process 110. Otherwise, the ticket service 120 can notify the fax transmission process 110 that the ticket 170 is not valid. Only upon receiving the validation message 180, will the fax transmission process 110 transmit the fax 150 to the intended fax recipient 140. Of course, where the ticket 170 is invalid, the fax transmission process 110 can send a denial message 190 to the fax sender 130.

Notably, the foregoing system and methodology can be implemented partially or wholly within a fax network. That is, each of the fax transmission process 110 and ticket service 120 can be incorporated as software modules to a broadcast fax network. Alternatively, the fax transmission process 110 can be a conventional facsimile device coupled to a computer network in which the ticket service 120 can be disposed. In either case, the skilled artisan will recognize that the inventive implementation of the Penny Black methodology in the facsimile domain is not limited to the particular illustrative system and process described herein. Rather, other variations of the foregoing methodology can achieve a similar result within the spirit of Penny Black.

For instance, the functionality of the ticket service 120 can be incorporated partially or wholly within the fax transmission process 110. Alternatively, the ticket service 120 can perform seamless validation of tickets 170 by simply refusing to validate an invalid ticket. In this case, the fax transmission process 110 can be programmed to transmit the fax 150 only upon receipt of a ticket. All other requests can be ignored. The ticket service 120, in turn, can assume responsibility for notifying the fax sender 130 of the denial. Other variations of shared responsibilities are further contemplated herein and will be apparent to the skilled artisan.

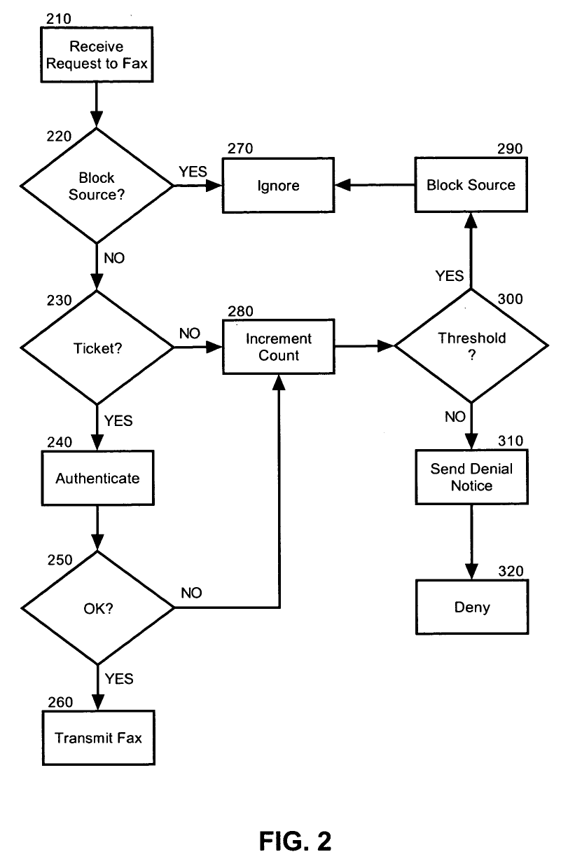

FIG. 2 is a flow chart illustrating a process of managing a ticket exchange in the transmission of a fax image from sender to recipient. Beginning in block 210, a request can be received from an identifiable sender to transmit a facsimile image to an intended recipient. In decision block 220, it can be determined whether facsimile images transmitted by the identifiable sender should be blocked based upon past events. If so, in block 270, the request to transmit the facsimile image can be ignored. Otherwise, the process can continue through decision block 230.

In decision block 230, it can be determined whether a ticket has been received in association with the facsimile image. In this regard, it will be presumed that all attempts to transmit a facsimile image will require participation in the ticket exchange system of the present invention. Of course, the skilled artisan will recognize that in alternative embodiments, ticket exchange participation may be selectively required, such as for example where suspect or unfamiliar members of the fax network community attempt to transmit a facsimile image. In any case, where a ticket has been included, in block 240 the ticket can be validated (and canceled from further use). If in decision block 250 the ticket has been validated, in block 260 the fax can be transmitted to its intended recipient.

Importantly, in either case of a ticket not having been included in association with the request, or where a ticket cannot be validated, the request to transmit the facsimile image can be denied and suitable notice can be forwarded to the identifiable sender. Yet, one skilled in the art will recognize that the act of notifying the identifiable sender can become burdensome to the identifiable sender where a large volume of denial messages arise from a substantial number of invalid requests. The problem of transmitting mass denial notices can be particularly problematic where a fax account within a fax network community has become hijacked by a rogue element. Such has become common in the electronic mail domain where the send mail resources of unwitting members of the mail community are used to broadcast high volumes of spam.

To address the foregoing problem, in accordance with the present invention, a number of denial instances can be tracked and where a threshold number of denials have been reached, all requests from the identifiable source can be blocked without the additional forwarding of a denial message. Returning now to FIG. 2 for a more particular illustration, in decision block 230 where a ticket has not been included in association with the request, a counter can be incremented for the identifiable sender in block 280. Similarly, in decision block 250 where the ticket cannot be validated, a counter can be incremented for the identifiable sender.

In both cases, in decision block 300 it can be determined whether the counter has exceeded a threshold value. If not, in block 310 a denial notice can be sent to the identifiable sender and the request can be denied in block 320. Otherwise, if in decision block 300 it can be determined whether the counter has exceeded the threshold value, in block 290 the identifiable source can be blocked from future transmissions and in block 270 the request can be ignored. Notably, though not illustrated within FIG. 2, where it is determined that the identifiable source no longer should be blocked, the counter can be reset and the block can be lifted. Similarly, the counter can be reset responsive to any number of business rules such as the lapsing of a period of time without increment, or following a certain number of successful transmissions. Importantly, it is to be understood by the skilled artisan that by limiting the processing of a number of invalid tickets, a denial-of-service type of attack launched against a fax community can be thwarted.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A fax transmission system comprising:
a fax transmission processor coupled to a ticket service and configured to transmit selected facsimile images only when said ticket service validates corresponding ones of tickets issued by said ticket service.

2. The fax transmission system of claim 1, wherein said fax transmission processor and said ticket service are disposed in a broadcast fax network.

3. The fax transmission system of claim 1, further comprising a plurality of counters associated with corresponding ones of identifiable fax senders, each said counter having a configuration for incrementing responsive to an invalid attempt to transmit a facsimile image on behalf of a corresponding one of said identifiable fax senders.

4. The fax transmission system of claim 3, wherein said fax transmission system is further configured to block processing of selected facsimile images for a specific one of said identifiable fax senders when a corresponding one of said counters exceeds a threshold value.

5. The fax transmission system of claim 1, further comprising a pricing function coupled to said ticket service and configured to determine whether tickets should be issued to requesters based upon a computation of resources consumed by said requestors.

6. A method for combating fax spam, the method comprising the steps of:
receiving a request to transmit a facsimile image from an identifiable sender;
validating and canceling a ticket received in association with said request; and,
blocking said request if said ticket does not validate.

7. The method of claim 6, further comprising the steps of:
computing a quantity of resources consumed by said identifiable sender in transmitting said facsimile image; and,
issuing said ticket only if said computed quantity exceeds a threshold value.

8. The method of claim 6, further comprising the steps of:
resetting a counter for said identifiable sender;
incrementing said counter each time a ticket received in association with a request from said identifiable sender does not validate; and,
blocking subsequent requests from said identifiable sender once said counter exceeds a threshold value.

9. The method of claim 6, further comprising the step of notifying said identifiable sender by electronic mail when said ticket does not validate.

10. The method of claim 8, further comprising the steps of:
resetting a counter for said identifiable sender;
incrementing said counter each time a ticket received in association with a request from said identifiable sender does not validate; and,
withholding notification for subsequent requests from said identifiable sender once said counter exceeds a threshold value.

11. A machine readable storage having stored thereon a computer program for combating fax spam, the computer program comprising a routine set of instructions for causing the machine to perform the steps of:
receiving a request to transmit a facsimile image from an identifiable sender;
validating and canceling a ticket received in association with said request; and,
blocking said request if said ticket does not validate.

12. The machine readable storage of claim 11, further comprising the steps of:
computing a quantity of resources consumed by said identifiable sender in transmitting said facsimile image; and,
issuing said ticket only if said computed quantity exceeds a threshold value.

13. The machine readable storage of claim 11, further comprising the steps of:
resetting a counter for said identifiable sender;
incrementing said counter each time a ticket received in association with a request from said identifiable sender does not validate; and,
blocking subsequent requests from said identifiable sender once said counter exceeds a threshold value.

14. The machine readable storage of claim 11, further comprising the step of notifying said identifiable sender by electronic mail when said ticket does not validate.

15. The machine readable storage of claim 13, further comprising the steps of:
resetting a counter for said identifiable sender;
incrementing said counter each time a ticket received in association with a request from said identifiable sender does not validate; and,
withholding notification for subsequent requests from said identifiable sender once said counter exceeds a threshold value.

16. A method for combating fax spam used in a denial of service attack on a fax community, the method comprising the steps of:
incrementing a counter each time a ticket received in association with a request from an identifiable sender of a facsimile does not validate; and,
blocking subsequent requests from said identifiable sender once said counter exceeds a threshold value.

17. A machine readable storage having stored thereon a computer program for combating fax spam used in a denial of service attack on a fax community, the computer program comprising a routine set of instructions which when executed by a machine cause the machine to perform the steps of:
incrementing a counter each time a ticket received in association with a request from an identifiable sender of a facsimile does not validate; and,
blocking subsequent requests from said identifiable sender once said counter exceeds a threshold value.
